(19) United States
(12) Patent Application Publication
(10) Pub. No.: US 2010/0013704 A1
(43) Pub. Date: Jan. 21, 2010

(54) PROCESS AND DEVICE FOR LOCATION-FINDING BY DETECTION OF RADIO SIGNAL EMITTERS

(76) Inventors: Simon Coutel, Maisons Laffitte (FR); Axel Von Arnim, Paris (FR); Francois Sebastien, Le Plessis Grammoire (FR)

Correspondence Address: YOUNG & THOMPSON, 209 Madison Street, Suite 500, Alexandria, VA, 22314, US

(21) Appl. No.: 12/446,829

(22) PCT Filed: Sep. 24, 2007
(86) PCT No.: PCT/FR07/51996

§ 371 Date: Aug. 31, 2009

(30) Foreign Application Priority Data
Oct. 23, 2006 (FR) 0654441

(51) Int. Cl. G01S 5/14

(52) U.S. Cl. 342/357.04; 342/386

(57) ABSTRACT

The invention relates to a location method characterised in that it comprises the following steps: a) receiving in a location device (1) signals from radio signal transmitters, each radio signal transmitter being capable of transmitting a digital frame including a header containing at least one transmitter identifier, and determining a list of identifiers containing an identifier for each transmitter; b) determining a set of candidate elements among sub-areas, or elements, of a geographic area; c) selecting the best candidate in the set of candidate elements; and d) locating said location device (1) in said element selected as the best candidate during step c).

The subjects of this invention are a process and a device for location-finding.

To determine the location of a device that can be carried aboard a vehicle or carried by a pedestrian, use of a satellite positioning system, for example a GPS system, is known. Such a system makes it possible to determine the exact positioning of the device based on the exact positions of a set of satellites using a triangulation algorithm.

However, satellite location-finding systems can lack accuracy, availability and/or reliability, especially when the propagation channel is obstructed by the presence of barriers, especially in an urban environment.

The development of wireless computerized communications systems entails large-scale installation of emitters. It can thus be advantageous to use these emitters for implementing a new location-finding system.

The document US 2006/0106850 describes a location-finding process using Wi-Fi networks in which a device transmits a request to all of the emitters within range of the device, records the responses of the emitters, decodes the identifiers of the emitters, and calculates the power of each received signal. The device then uses a database containing the positions of the emitters to determine the position of the device by triangulation.

However, the power measurements for the signals emitted by IEEE 802.11 (2.45-5 GHz) emitters, for example Wi-Fi emitters, can, in a given location, be exposed to unforeseeable fluctuations due to weather conditions, the relative speed between the receiver and the emitter, the presence of obstacles in the vicinity, the geometry of the environment in the vicinity of the emitter or receiver, etc. Location-finding by triangulation relative to a constellation of IEEE 802.11 emitters thus does not allow solid, reliable and accurate location-finding.

The purpose of this invention is to suggest a location-finding device and process that avoid at least some of the aforementioned drawbacks and that allow solid, reliable and accurate location-finding.

For this purpose, the object of the invention is a location-finding process that is characterized in that it comprises the following stages consisting in:

a) receiving, in a location-finding device, signals originating from radio signal emitters, each radio signal emitter being able to emit a digital frame whose header contains at least one identifier of the emitter, and determining a list of identifiers containing one identifier of each emitter from which at least one signal has been received,

b) determining, by comparing said list of identifiers that is determined at stage a) with lists of identifiers stored in a location-finding database, a set of candidate elements, each identifier list stored in said location-finding database being linked to a subzone, i.e., an element, of a geographical zone,

c) selecting the best candidate from among said set of candidate elements using a set of selection criteria comprising at least one criterion relative to the volatile nature of an emitter whose identifier belongs to a list of identifiers linked to a candidate element, and

d) finding the location of said location-finding device in said element that is selected as the best candidate in stage c).

According to one embodiment of the invention, the location-finding process comprises an additional stage consisting in estimating the position of said location-finding device by using the location-finding of said location-finding device that is defined in stage d) and a model of the development of the movements of said location-finding device.

Preferably, stage b) comprises sub-stages consisting in:

e) determining a correlation factor between said identifier list determined at stage a) and an identifier list stored in said location-finding database, and

f) when said correlation factor is greater than a predefined threshold, selecting said element that is linked to said identifier list that is stored in said database as a candidate element.

Advantageously, said location-finding database comprises topological data relating to the position of the elements relative to one another, the stages e) and f) being implemented for a list of identifiers that is linked to the element in which said location-finding device was located at the last implementation of said location-finding process and for each list of identifiers that is linked to an element that is adjacent to the element in which said location-finding device was located at the last implementation of said location-finding process.

According to one embodiment of the invention, said set of selection criteria comprises at least one criterion relative to a ratio between said identifier list determined at stage a) and an identifier list that is stored in said location-finding database and/or a criterion relative to consideration of the continuity of the movement of said location-finding device.

According to one embodiment of the invention, stage a) comprises a sub-stage consisting in measuring the power of each received signal, said set of selection criteria comprising at least one criterion relative to the power of a received signal.

Advantageously, the location-finding process is combined with an updating process, implemented after stage d), comprising a stage consisting in:

g) determining an identifier of an emitter whose signal has been received at stage a) and that does not belong to the list of identifiers that is linked to said element that is selected as the best candidate and storing said identifier in the identifier list linked to said element that is selected as the best candidate.

According to one embodiment of the invention, said location-finding device comprises means of connection to the Internet.

Advantageously, in this embodiment, at stage g), the criterion relative to the volatile nature of said emitter whose identifier is stored is fixed at a low value, said updating process comprising stages consisting in connecting said location-finding device to an Internet updating site, comparing an identifier stored in stage g) with the contents of an updating database, and, depending on said comparison, updating the value of said criterion relative to the volatile nature of the emitter in said location-finding database.

According to one embodiment of the invention, said location-finding device is used in combination with a sensor indication device.

According to one embodiment of the invention, said location-finding device can work with a satellite positioning system, said location-finding process comprising the stages consisting in:

h) determining a first confidence index linked to said satellite positioning system,

i) determining a second confidence index linked to said location-finding device,

j) comparing said first and second confidence indices and, depending on the comparison, determining if the location-finding should be determined based on said satellite positioning system, based on said location-finding device, or based on a combination of said satellite positioning system and said location-finding device.

The object of the invention is likewise a location-finding device using the location-finding process.

The invention will be better understood, and other objectives, details, characteristics and advantages of the latter will appear more clearly during the following detailed explanatory description of several embodiments of the invention given by way of purely illustrative and nonlimiting examples, with reference to the attached schematics.

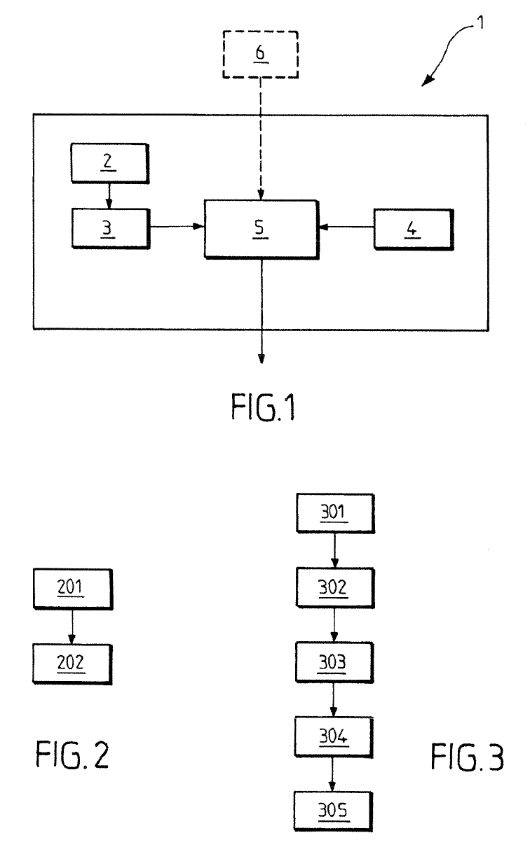

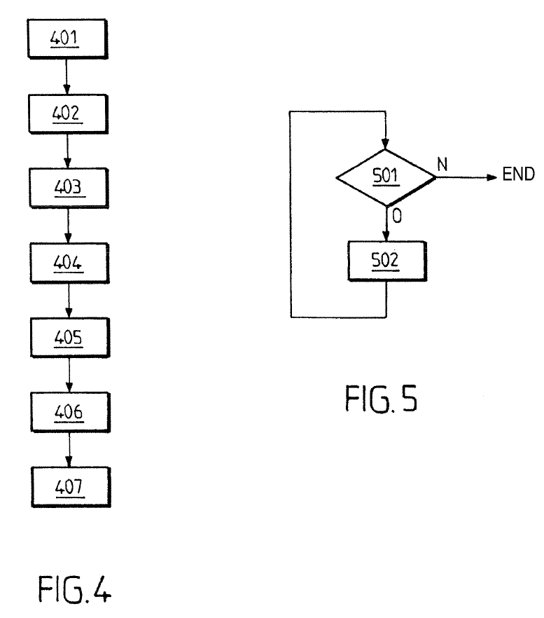

In these drawings:
FIG. 1 is a functional schematic of a location-finding device according to one embodiment of the invention;
FIG. 2 is a functional diagram representing the stages of a process of plotting a digital map that is designed to be used by the location-finding device of FIG. 1;
FIG. 3 is a functional diagram representing the stages of a location-finding process implemented by the location-finding device of FIG. 1;
FIG. 4 is a functional diagram representing the stages of a second location-finding process;
FIG. 5 is a functional diagram representing the stages of an automatic updating process.

Let us consider a geographical zone that can be, for example, a city, a region, etc. Radio signal emitters are distributed in an unknown manner in the geographic zone. Each emitter can emit a digital signal that is broken down into frames, the header of one frame containing at least one identifier of the emitter. In other words, the emitters observe the standards issued by the IEEE 802 Working Group and can be, for example, Wi-Fi, Wi-max, Bluetooth, ZigBee, etc., emitters. An identifier can be assigned uniquely to each emitter. As a variant, several emitters can have the same identifier.

In the described embodiment, the emitters are Wi-Fi emitters.

FIG. 1 shows a location-finding device 1 comprising a receiver 2, a passive listening module 3, a data storage module 4, and a processing module 5.

The receiver 2 can receive Wi-Fi signals emitted by emitters located in the vicinity of the device 1. The listening module 3 is designed to implement passive listening of the signals received by the receiver 2 and to determine an identifier of each visible emitter, i.e., of each emitter for which at least one signal has been received.

The storage module 4 comprises, for example, a ROM-type memory (read-only memory) for storing routines and a digital map linked to the geographical zone, and a RAM-type memory (random access memory) for storing the data determined or calculated during implementation of a location-finding process that will be described in detail below.

The processing module 5 is designed especially for determining the location of the device 1 by using a list of identifiers determined by the listening module 3.

The location-finding device 1 that, for example, has the shape of a box, can be located in a vehicle or can be carried by a walking user. As a variant, the location-finding device can be integrated into a PDA (Personal Digital Assistant), a mobile phone, or the like.

In the text, the terms “position” and “positioning” designate the determination of geographical data, i.e., the coordinates of an object in a given reference system (WGS84, Lambert, etc.). The term “digital map” designates a set of data or a database relative to the geographical zone, the database digitizing the geographical zone into linear, surface or volumetric elements and containing information relating to the topology of the elements, i.e., the position of the elements relative to one another. The term “location-finding” designates the determination of a position of an object on the digital map. In other words, location-finding designates the action of determining that an object belongs to an element of the digital map, the verb “belong” indicating being on a linear element, in a surface element, or in a volumetric element, depending on the type of element.

With reference to FIG. 2, the stages of a process of plotting a digital map linked to the geographical zone will now be described. This process is implemented by a digital map plotting device (not shown), comprising storage means, Wi-Fi signal receiving means, and data processing means.

At stage 201, the geographical zone is broken down into sub-zones, i.e., elements E. An element E can be a segment, a surface element, or an element of volume. An element E is continuous and connected. The dimensions of an element E depend especially on its environment, i.e., the elements E do not necessarily have all the same dimensions. An element E₁ of the geographical zone can be, for example, a road, an element E₂ of the geographical zone can be a part of a road, an element E₃ of the geographical zone can be an intersection, etc.

For each element Eₖ, k being a positive integer, data are stored in the storage means. In the text below, the digital entity ENₖ will be called the set of data relative to element Eₖ, this not implying a particular arrangement of these data in the storage means. The digital entity ENₖ comprises coordinates of element Eₖ in the geographical zone and topological data relative to the position of element Eₖ relative to other elements, i.e., data relative to elements E that are adjacent to element Eₖ.

At stage 202, the digital map plotting device is located in an element E, for example the element E₁. At this instant, the receiving means receive signals originating from emitters located in the vicinity. The identifier of each visible emitter is stored in the digital entity EN that is linked to the element E in which the device is located, here the digital entity EN₁. An identifier list linked to the element E₁ is thus compiled and stored. For each visible emitter, the device evaluates the volatile nature of the emitter and stores a weight that is linked to the emitter in the digital entity EN₁.

When stage 202 has been completed, the device is moved into another element, and stage 202 is repeated. Stage 202 is repeated until the set of the geographical zone has been mapped, i.e., until a list of identifiers of visible emitters has been determined and stored for each element E.

The digital map is then transmitted to the location-finding device 1 and stored in the storage module 4.

As a variant, the digital map can be stored in a device that is remote from the location-finding device 1. In this case, the location-finding device 1 comprises means of transmission-reception, allowing it to access the digital map, for example means of connection to the Internet.

With reference to FIG. 3, the stages of a process of location-finding implemented by the location-finding device 1 will now be described.

At stage 301, the listening module 3 decodes the Wi-Fi signals received by the receiver 2 and creates a list of identifiers comprising one identifier of each visible emitter. Let us note that the listening module 3 only decodes the “beacon” frames, i.e., the frames containing the identifier of the emitter. The listening module 3 transmits the list of identifiers to the processing module 5.

At stage 302, the processing module 5 selects a digital entity ENᵢ, i being a positive integer.

The entity ENᵢ is preferably selected using a history of the movements of the device 1, i.e., the selected digital entity ENᵢ is preferably linked to the element Eₙ in which the device 1 was located in the previous implementation of the process, i.e., i=n, or to an element E adjacent to the element Eₙ. If there is no history, for example during the first implementation of the location-finding process, the entity ENᵢ is, for example, selected randomly.

The module 5 compares the identifier list transmitted by the listening module 3 to the identifier list stored in the selected entity ENᵢ and from it deduces a correlation factor γᵢ,

When the correlation factor γᵢ is greater than a predetermined threshold, the processing module 5 selects the element Eᵢ as a candidate element, i.e., as the element E in which the device 1 could be found.

The stage 302 is repeated for a set of digital entities EN. When there is a history of movements of the device 1, the set of entities comprises, for example, the entity ENₙ linked to the element Eₙ in which the device 1 was located in the previous implementation of the process and entities EN linked respectively to elements E adjacent to element Eₙ. It should be noted that the history of movements used to determine the set of entities is limited to movements made during the current use of the device 1, i.e., the process does not consider movements that could have been made and stored previously if the device 1 had been off or inactive since then. When there is no history, the set of entities comprises, for example, all of the entities EN that are stored in the storage module 4.

At stage 303, the processing module 5 for each candidate element calculates a score based on a set of selection criteria stored in the corresponding digital entity EN. The score is tied to the probability of the candidate element being the element E in which the device 1 is actually located.

The set of selection criteria comprises, for example, a criterion relative to the weight that provides information about the volatile nature of each emitter of the identifier list. Thus, an emitter that is considered to be very volatile can have less importance than an emitter that is considered to be of low volatility in the calculation of the score. In other words, the non-detection of a very volatile emitter at stage 301 should not have too much influence on the score of the candidate element.

The set of selection criteria can likewise comprise a criterion relative to a ratio between the visible emitters (whose identifier belongs to the identifier list transmitted by the listening module 3) and the emitters linked to a candidate element (whose identifier belongs to the identifier list stored in the corresponding entity EN).

When there is a history of movements of the device 1, the set of selection criteria can likewise comprise a criterion relative to consideration of the continuity of the movements of the device 1. For example, if the user of the device 1 had moved along a road, he cannot be located on a parallel road in the next implementation of the process. It should be noted that a history of the movements for current use of the device 1 is also considered here.

The processing module 5 selects as the best candidate, i.e., the most probable candidate, the candidate element whose score is the highest. For example, the element Eₚ is selected.

At stage 304, the module 5 locates the device 1 in the element E that is selected as the best candidate at stage 303, here element Eₚ.

The location-finding data are transmitted at the outlet of the processing module 5 and can be used, for example, by a navigation device (not shown).

Moreover, the location-finding data are stored as the history of the movements in the storage module 4. The current location is compared to past locations and, if need be, the data relative to the transitions of the element E, i.e., an entry time into the element E or an exit time from the element E, are likewise stored in the storage module 4. The history is used during the following implementations of the process for calculating the score of a candidate element. The history is likewise used to reduce the number of entities to be tested at stage 302; this allows more prompt implementation of the location-finding process.

At stage 305, the processing module 5 determines an estimation of the position of the device 1 based on the coordinates of the element E on which the device 1 has been located and on a model of the development of the movements of the device 1. When the device 1 is located in a vehicle, the development model is based especially on the average speed of the vehicle. The development model is likewise based on the history of the movements on the M last elements E, M being an integer greater than 1. The position data are transmitted at the outlet of the processing module 5 and can be used by, for example, a navigation device (not shown) that is designed to process position data; this is especially the case of a navigation device of the type that is used with a satellite positioning system.

The location-finding process that is described above adopts a methodology that is the reverse of that used in a system of position-finding by triangulation. This location-finding process allows a device 1 to be located in a geographical zone based on a digital map of the geographical zone, a database of visible emitters in each element of the geographical zone, and on the detection of visible emitters in the vicinity of the device 1.

Thus, it is not necessary to know the position of the emitters; it is enough to determine what emitters are visible starting from the current position of the device 1.

This location-finding process thus makes it possible to dispense with emitter position data, low-reliability power measurements of the signals of IEEE 802.11 emitters, and the problem associated with relative speeds between emitters and receiver (disruption of the power measurement).

With reference to FIG. 4, a second location-finding process will now be described. Here, the location-finding device 1 works with a satellite positioning system 6 (shown by broken lines in FIG. 1).

Stages 401 to 405 are similar to stages 301 to 305 described above.

At stage 406, the satellite positioning system 6 determines the position of the device 1 by triangulation.

At stage 407, the processing module 5 determines a confidence factor f_{GPS} linked to the satellite positioning system 6 that is especially a function of the number of satellites used for determining the position of the device at stage 405. Similarly, the processing module 5 determines a confidence factor f_{Wi-Fi} linked to the location-finding device 1 that is especially a function of the number of Wi-Fi emitters used for determining the location of the device 1 at stage 404.

As a function of the ratio between the confidence factors f_{GPS} and f_{Wi-Fi}, the processing module 5 determines if the position should be determined based on the satellite positioning system 6, based on the location-finding device 1, or based on a combination of the satellite positioning system 6 and the location-finding device 1. In the latter case, the position that is determined by the satellite positioning system 6 is corrected by the location determined by the device 1.

The second location-finding process makes it possible to obtain more reactive location-finding and/or navigation. Moreover, it makes it possible to eliminate problems of transitions between the zones in which the satellite positioning system 6 operates, i.e., the zones in which enough satellites are visible, and those in which the device 1 is operating, i.e., the zones in which there are enough Wi-Fi emitters.

Other variants are possible. For example, although Wi-Fi emitters periodically automatically send “beacon” frames, i.e., signals containing the identifier of the emitter, the device 1 can emit “request” frames asking for the emitters to transmit their identifier. This variant makes it possible to obtain the identifier of each visible emitter more promptly.

The device 1 can measure the power of the signals that are received and can deduce from it, for each emitter, an indicator of the level of the power received. In this case, the set of selection criteria can comprise a criterion relative to the level of power received, for example only signals that are strong enough are considered. It should be noted that it is only a matter of an indicator of the proximity of the emitters linked to an element and not a strategy of relative positioning by triangulation, since the relative and exact positions of the emitters are unknown.

When the device 1 is located in a vehicle, it can work with a sensor indication device (steering wheel angle sensor, electronic compass, accelerometric sensor, . . . ). The data transmitted by the sensor indication device allow especially good detection of intersections when the vehicle is turning. This makes it possible to refine the location obtained by the above-described location-finding process. It should be noted that a sensor indicator does not have inertia and thus makes it possible to “reset” the device 1.

The device 1 can be programmed to carry out an automatic updating process whose stages will be described with reference to FIG. 5. The updating process is implemented after the location-finding stage 304 or 404.

At stage 501, the device 1 tests a condition of existence of an identifier of an emitter whose signal has been received at stage 301 and that does not belong to the list of identifiers linked to said element selected as the best candidate at stage 303. When the condition has been verified, the device 1 passes to stage 502; if not, the automatic updating process ends.

At stage 502, the device 1 stores the identifier in the identifier list linked to the element that is selected as the best candidate. By default, the emitter is considered to be very volatile, and the weight linked to the emitter is then initialized at a low value. Thus, this emitter will have a limited influence on the location-finding of the device 1 during the following implementations of the location-finding process. The process returns to stage 501.

Stages 501 and 502 thus allow automatic updating of the storage means when the Wi-Fi emitters are adjusted or replaced.

In this variant, the automatic updating process can comprise a local updating stage. The local updating stage consists in increasing the weight linked to an emitter that had been detected during passage to stage 501 when the emitter is again detected in the same element.

In this variant, the automatic updating process can comprise a statistical updating stage. The statistical updating stage can be carried out in addition to or instead of the local updating stage. Here, the location-finding device 1 comprises means of connection to the Internet. When the user connects the device 1 to the Internet and accesses an updating site, each identifier stored in stage 502 is stored in the updating database of the site as linked to the corresponding element. Thus, the updating database is supplemented by each user connecting to the updating site.

Each identifier stored in stage 502 is compared to the contents of the updating database. A statistical comparison, i.e., a comparison between what the user device 1 has detected and what the similar devices of other users have detected, makes it possible to validate or not validate the identifier belonging to the corresponding identifier list. Updating data are then transmitted with the destination of the device 1 and stored in the storage means 4. These data comprise, for example, a new weight linked to an identifier that is stored at stage 502 that has been validated, another identifier linked to an element that has not yet been detected by the device 1 of the user at stage 501, for example because the user has not moved into the corresponding element, and/or a command for elimination of an identifier stored at stage 502 that has not been validated.

Although the invention had been described in relation to several particular embodiments, it is quite evident that it is in no way limited thereto and that it includes all of the technical equivalents of the described means as well as their combinations if the latter fall within the scope of the invention.

1. Location-finding process, characterized in that it comprises the stages consisting in:
a) receiving (301, 401), in a location-finding device (1), signals originating from radio signal emitters, each radio signal emitter being able to emit a digital frame whose header contains at least one identifier of the emitter, and determining a list of identifiers containing one identifier of each emitter from which at least one signal has been received,
b) determining (302, 402), by comparing said list of identifiers determined at stage a) to lists of identifiers stored in a location-finding database, a set of candidate elements, each identifier list stored in said location-finding database being linked to a subzone, i.e., an element (E), of a geographical zone,
c) selecting (303, 403) the best candidate from among said set of candidate elements using a set of selection criteria comprising at least one criterion relative to the volatile nature of an emitter whose identifier belongs to a list of identifiers linked to a candidate element, and
d) finding the location (304, 404) of said location-finding device (1) in said element (E) that is selected as the best candidate in stage c).

2. Location-finding process according to claim 1, wherein it comprises an additional stage consisting in estimating (305, 405) the position of said location-finding device (1) by using the location-finding of said location-finding device that is defined in stage d) and a model of the development of the movements of said location-finding device.

3. Location-finding process according to claim 1, wherein stage b) comprises sub-stages consisting in:
e) determining a correlation factor (γᵢ) between said identifier list that is determined at stage a) and an identifier list that is stored in said location-finding database, and
f) when said correlation factor (γᵢ) is greater than a predefined threshold, selecting said element (Eᵢ) that is linked to said identifier list that is stored in said database as a candidate element.

4. Location-finding process according to claim 3, wherein said location-finding database comprises topological data relating to the position of the elements relative to one another, the stages e) and f) being implemented for a list of identifiers that is linked to the element (E) in which said location-finding device (1) was located at the last implementation of said location-finding process and for each list of identifiers that is linked to an element that is adjacent to the element (E) in which said location-finding device was located at the last implementation of said location-finding process.

5. Location-finding process according to claim 1, wherein said set of selection criteria comprises at least one criterion relative to a ratio between said identifier list determined at stage a) and an identifier list stored in said location-finding database and/or a criterion relative to consideration of the continuity of movement of said location-finding device (1).

6. Location-finding process according to claim 1, wherein stage a) comprises a sub-stage consisting in measuring the power of each received signal, said set of selection criteria comprising at least one criterion relative to the power of a received signal.

7. Location-finding process according to claim 1, wherein it is combined with an updating process, implemented after stage d), comprising a stage consisting in:
g) determining (501) an identifier of an emitter whose signal has been received at stage a) and that does not belong to the list of identifiers that is linked to said element that is selected as the best candidate and storing (502) said identifier in the identifier list linked to said element that is selected as the best candidate.

8. Location-finding process according to claim 7, wherein said location-finding device (1) comprises means of connection to the Internet.

9. Location-finding process according to claim 8, wherein at stage g), the criterion relative to the volatile nature of said emitter whose identifier is stored is fixed at a low value, said updating process comprising stages consisting in connecting said location-finding device to an Internet updating site, comparing an identifier stored in stage g) with the contents of an updating database, and, depending on said comparison, updating the value of said criterion relative to the volatile nature of the emitter in said location-finding database.

10. Location-finding process according to claim 1, wherein said location-finding device (1) is used in combination with a sensor indication device.

11. Location-finding process according to claim 1, wherein said location-finding device (1) can work with a satellite positioning system (6), said location-finding process comprising the stages consisting in:
h) determining a first confidence index (f_{GPS}) linked to said satellite positioning system (6),
i) determining a second confidence index (f_{Wi-Fi}) linked to said location-finding device (1),
j) comparing said first and second confidence indices and, depending on the comparison, determining if the location must be determined based on said satellite positioning system (6), based on said location-finding device (1), or based on a combination of said satellite positioning system (6) and said location-finding device (1).

12. Location-finding device using the location-finding process according to claim 1.

13. Location-finding process according to claim 2, wherein stage b) comprises sub-stages consisting in:
e) determining a correlation factor (γᵢ) between said identifier list that is determined at stage a) and an identifier list that is stored in said location-finding database, and
f) when said correlation factor (γᵢ) is greater than a predefined threshold, selecting said element (Eᵢ) that is linked to said identifier list that is stored in said database as a candidate element.
